(19) United States
(12) Patent Application Publication
(10) Pub. No.: US 2026/0356347 A1
(43) Pub. Date: Nov. 12, 2026

(54) ROUTE INFORMATION MONITORING APPARATUS FOR HYBRID ELECTRIC VEHICLE AND METHOD THEREFOR

(71) Applicants: Hyundai Motor Company, Seoul (KR); Kia Corporation, Seoul (KR)

(72) Inventor: Bon Chang KOO, Hwaseong-si (KR)

(73) Assignees: Hyundai Motor Company, Seoul (KR); Kia Corporation, Seoul (KR)

(21) Appl. No.: 19/390,235

(22) Filed: Nov. 14, 2025

(30) Foreign Application Priority Data
May 8, 2025 (KR) 10-2025-0059434

(51) Int. Cl. B60W 20/13; B60W 10/06; B60W 20/12

(52) U.S. Cl. CPC B60W 20/13; B60W 10/06; B60W 20/12; B60W 2510/244; B60W 2520/10; B60W 2530/18; B60W 2710/06; B60W 2710/244

(57) ABSTRACT

A route information monitoring apparatus for a hybrid vehicle, includes a navigation system that provides route information to a set destination, and a vehicle controller operatively connected to the navigation system and obtaining a first driving distance during a preset time period based on the route information, obtains a second driving distance that is an actual driving distance during the same time period as the preset time period, compares the first driving distance with the second driving distance to determine consistency of the route information for target SoC charging control, and determines whether to operate an engine of the vehicle for selective battery charging.

### CROSS-REFERENCE TO RELATED APPLICATION

The present application claims, under 35 U.S.C. § 119 (a), the benefit of and priority to Korean Patent Application No. 10-2025-0059434 filed on May 8, 2025, the entire contents of which are incorporated herein by reference.

### BACKGROUND

### Field of the Present Disclosure

The present disclosure relates to an SoC control monitoring apparatus for a hybrid electric vehicle and a method therefor, and more specifically, to a route information monitoring apparatus for a vehicle, configured for determining consistency of route information received from a vehicle navigation system to monitor a normal state thereof, and a method therefor.

### Description of Related Art

In general, a hybrid electric vehicle (HEV) uses two power sources, namely, an engine and an electric motor.

State of charge (SoC) control of a battery provided in the hybrid electric vehicle is an important factor determining fuel economy and exhaust performance of the hybrid electric vehicle. The amount of assist and the amount of regenerative braking may be determined by the SoC value of the battery.

In controlling the SoC value of the battery, the most important entity is to ensure that the battery operates at the highest efficiency point, and the charging/discharging efficiency varies depending on the SoC value of the battery due to characteristics of the battery.

The SoC value of the battery is usually divided into three sections, that is, a normal section, an over-charge section, and an over-discharge section according to the characteristics of the charging/discharge efficiency. The normal section is a section corresponding to ±5% with reference to 55% to 60% of the SoC value of the battery, the over-charge section is a section corresponding to 65% or higher of the SoC value of the battery, which is an upper level of the normal section, and the over-discharge section is a section corresponding to 55% or lower of the SoC value of the battery, which is a lower level of the normal section.

In this regard, a general battery charge/discharging control strategy of the hybrid electric vehicle is regarded as a passive state variable rather than an active control variable, and thus, a strategy for maintenance control of the SoC within a predetermined operating section has been mainly adopted.

Typical SoC maintenance control methods for hybrid electric vehicles include Max SoC control, thermostat control, and Baseline control.

In the case of the above-mentioned three SoC maintenance strategies, a limit range of a maximum value and a minimum value of an SoC that is a state variable may be set, and in a case where the SoC value is within the limit range, no control strategy is executed.

Therefore, it cannot be said that such an SoC maintenance strategy is a method for utilizing electrical energy as an active battery SoC control strategy, but it can be said that the SoC maintenance strategy is a realistic method in a state where it is not possible to predict future situations of vehicle driving. However, in a case where a driving situation can be predicted using Global Positioning System (GPS) and a navigation system, it is possible to establish a control strategy different from the existing techniques (See Japanese Laid-open Patent Publication No. 2007-0126145).

The above information disclosed in this Background section is only for enhancement of understanding of the background of the present disclosure and therefore it may include information that does not form the related art that is already known in the present country to a person of ordinary skill in the art.

### BRIEF SUMMARY

The present disclosure has been made in an effort to solve the above-described problems associated with related art, and it is an aspect of the present disclosure to provide a route information monitoring apparatus for a hybrid electric vehicle and a method therefor, configured for checking the consistency of route information by receiving information on a route to a destination from a navigation system, based on information on an average speed, a driving distance at each average speed, and a slope, comparing a driving distance based on the navigation system and an actual driving distance, and monitoring whether the route information received from the navigation system is normal.

In one aspect, the present disclosure provides a route information monitoring apparatus for a hybrid vehicle, including a navigation system that provides route information to a set destination, and a vehicle controller operatively connected to the navigation system and obtaining a first driving distance during a preset time period based on the route information, obtains a second driving distance that is an actual driving distance during the same time period as the preset time period, compares the first driving distance with the second driving distance to determine consistency of the route information for a target SoC charging control, and determines whether to operate an engine of the vehicle for selective battery charging.

In an exemplary embodiment of the present disclosure, the vehicle controller may determine, based on concluding that a difference between the first and second driving distances is less than a reference driving distance, that the provided route information is normal.

In another exemplary embodiment of the present disclosure, the vehicle controller may determine, based on concluding that a difference between the first and second driving distances exceeds a reference driving distance, that an error has occurred in the route information, and may perform control for stopping the target SoC charging control.

In yet another exemplary embodiment of the present disclosure, the vehicle controller may obtain a total used SoC value used by the vehicle to reach a destination at an end of driving of the vehicle, compares the total used SoC value with a total estimated SoC value to the destination obtained based on the route information, and may perform control for selectively stopping the target SoC charging control.

In yet another exemplary embodiment of the present disclosure, the vehicle controller may determine, based on concluding that a difference between the total used SoC value and the total estimated SoC value is less than a preset error range, that the obtaining of the total estimated SoC value based on the route information is normal.

In still yet another exemplary embodiment of the present disclosure, the vehicle controller may determine, based on concluding that a difference between the total used SoC value and the total estimated SoC value exceeds a preset error range, that an error has occurred in the obtaining of the total estimated SoC value based on the route information, and may perform control for stopping the target SoC charging control.

In a further exemplary embodiment of the present disclosure, the target SoC charging control may include obtaining a total estimated SoC value to the destination using the route information including an average speed of the vehicle, the driving distance at each average speed, and a slope received from the navigation system, and selectively performing charging control or discharging control through the vehicle controller.

In another further exemplary embodiment of the present disclosure, the target SoC charging control may include obtaining a charging SoC value necessary for additional charging of a battery of the vehicle through a difference between the total estimated SoC value and a current SoC value, and performing the charging control so that the current SoC value follows the target SoC value through the vehicle controller, by the vehicle controller, based on concluding that the charging SoC value is greater than the current SoC value.

In yet another further exemplary embodiment of the present disclosure, the target SoC charging control may include performing the charging control or the discharging control by the vehicle controller so that the current SoC value is maintained at the target SoC value, based on concluding that the charging SoC value is less than the current SoC value.

In yet another further exemplary embodiment of the present disclosure, the target SoC charging control may include selectively performing the discharging control by the vehicle controller, based on concluding that the charging SoC value is less than 0.

In another aspect, the present disclosure provides a route information monitoring method for a hybrid electric vehicle, including receiving route information to a destination preset in a navigation system from a vehicle controller, obtaining a first driving distance during a preset time period based on the route information, by the vehicle controller, obtaining a second driving distance that is an actual driving distance during the same time period as the preset time period, by the vehicle controller, comparing the first driving distance with the second driving distance to determine consistency of the route information for a preset target SoC charging control, by the vehicle controller, and determining whether to operate an engine of the vehicle for selective battery charging, by the vehicle controller.

In an exemplary embodiment of the present disclosure, the determining of the route information consistency may include determining, based on concluding that a difference between the first and second driving distances is less than a reference driving distance, that the provided route information is normal.

In another exemplary embodiment of the present disclosure, the determining of the route information consistency may include determining, based on concluding that a difference between the first and second driving distances exceeds a reference driving distance, that an error has occurred in the route information, and performing control for stopping the target SoC charging control.

In yet another exemplary embodiment of the present disclosure, the method may further include obtaining a total used SoC value used by the vehicle to reach a destination at an end of driving of the vehicle, comparing the total used SoC value with a total estimated SoC value to the destination obtained based on the route information, and performing control for selectively stopping the target SoC charging control, by the vehicle controller.

In yet another exemplary embodiment of the present disclosure, based on concluding that a difference between the total used SoC value and the total estimated SoC value is less than a preset error range, a determination may be made that the obtaining of the total estimated SoC value based on the route information is normal.

In still yet another exemplary embodiment of the present disclosure, based on concluding that a difference between the total used SoC value and the total estimated SoC value exceeds a preset error range, a determination may be made that an error has occurred in the obtaining of the total estimated SoC value based on the route information, and control for stopping the target SoC charging control may be performed.

In a further exemplary embodiment of the present disclosure, the target SoC charging control may include obtaining a total estimated SoC value to the destination using the route information including an average speed of the vehicle, the driving distance at each average speed, and a slope received from the navigation system, and selectively performing charging control or discharging control through the vehicle controller.

In another further exemplary embodiment of the present disclosure, the target SoC charging control may include obtaining a charging SoC value necessary for additional charging of a battery of the vehicle through a difference between the total estimated SoC value and a current SoC value, and performing the charging control so that the current SoC value follows the target SoC value through the vehicle controller, by the vehicle controller, based on concluding that the charging SoC value is greater than the current SoC value.

In yet another further exemplary embodiment of the present disclosure, the target SoC charging control may include performing the charging control or the discharging control by the vehicle controller so that the current SoC value is maintained at the target SoC value, based on concluding that the charging SoC value is less than the current SoC value.

In yet another further exemplary embodiment of the present disclosure, the target SoC charging control may include selectively performing the discharging control by the vehicle controller, based on concluding that the charging SoC value is less than 0.

Other aspects and exemplary embodiments of the present disclosure are discussed infra.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure.

FIG. 1 is a diagram showing a configuration of a route information monitoring apparatus for a hybrid electric vehicle according to an exemplary embodiment of the present disclosure;

FIG. 2 is a diagram showing a vehicle structure for a route information monitoring apparatus for a hybrid electric vehicle according to an exemplary embodiment of the present disclosure;

FIG. 3 is a diagram showing a target SoC charging control for a route information monitoring apparatus for a hybrid electric vehicle according to an exemplary embodiment of the present disclosure;

FIG. 4 is a diagram sequentially showing destination setting for a route information monitoring method for a hybrid electric vehicle according to another exemplary embodiment of the present disclosure;

FIG. 5 is a diagram sequentially showing a target SoC charging control for a route information monitoring method for a hybrid electric vehicle according to another exemplary embodiment of the present disclosure;

FIG. 6 is a diagram sequentially showing determination of first route information consistency for a route information monitoring method for a hybrid electric vehicle according to another exemplary embodiment of the present disclosure; and

FIG. 7 is a diagram sequentially showing determination of second route information consistency for a route information monitoring method for a hybrid electric vehicle according to another exemplary embodiment the present disclosure.

### DETAILED DESCRIPTION

Reference will hereinafter be made in detail to various embodiments of the present disclosure, examples of which are illustrated in the accompanying drawings and described below. While the present disclosure will be described in conjunction with exemplary embodiments of the present disclosure, it will be understood that present description is not intended to limit the present disclosure to the exemplary embodiments. On the contrary, the present disclosure is intended to cover not only the exemplary embodiments of the present disclosure, but also various alternatives, modifications, equivalents and other embodiments, which may be included within the spirit and scope of the present disclosure as defined by the appended claims.

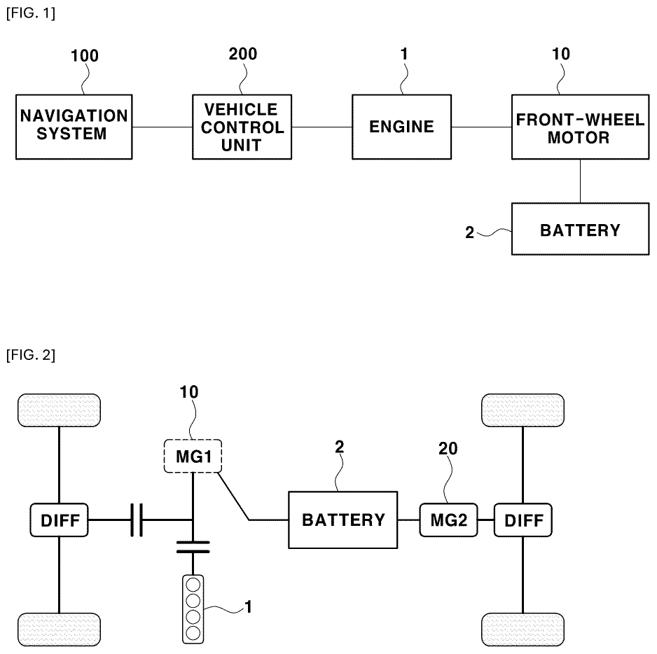

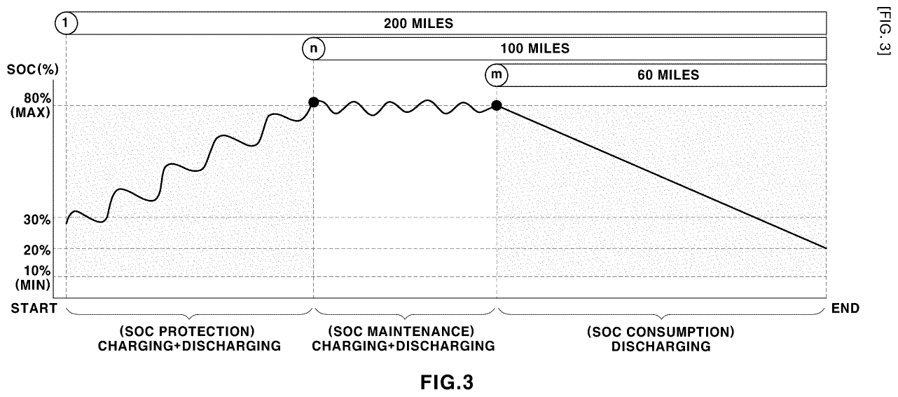

FIG. 1 is a diagram showing a configuration of a route information monitoring apparatus for a hybrid electric vehicle according to an exemplary embodiment of the present disclosure, FIG. 2 is a diagram showing a vehicle structure for a route information monitoring apparatus for a hybrid electric vehicle according to an exemplary embodiment of the present disclosure, and FIG. 3 is a diagram showing a target SoC charging control for a route information monitoring apparatus for a hybrid electric vehicle according to an exemplary embodiment of the present disclosure.

In general, an extended-range electric vehicle (EREV) uses two motors including a front-wheel motor 10 and a rear-wheel motor 20. Here, in a case where power generation is performed as a state of charge (SOC) value of a battery 2 becomes low, it is difficult to perform 4WD for operating both the motors for front-wheel drive and rear-wheel drive.

In other words, the front-wheel motor 10 is used as a drive motor in a case where the SoC value of the battery 2 is high, but in a case where the SoC value of a battery 2 is low, the front-wheel motor 10 performs power generation to charge the battery 2, and thus, the front-wheel motor 10 cannot perform 4WD due to the power generation in a case where the SoC value of the battery is low.

Accordingly, by setting, based on route information to a destination, a target SoC value, a maximum SoC value, and turning on an engine 1 only under necessary circumstances to satisfy the set maximum SoC value, that is, selectively performing power generation for the battery 2, it is possible to perform the SoC maintenance control of the battery 2.

Here, in a case where the engine 1 is turned on to satisfy the maximum SoC value, the engine 1 may be unnecessarily turned on, and in the instant case, exhaust gas may increase. Therefore, it is necessary to monitor whether the target SoC setting is normally performed based on a driving route to the destination.

To the present end, the route information monitoring apparatus for the hybrid electric vehicle according to the exemplary embodiment includes a navigation system 100 and a vehicle controller 200, as shown in FIG. 1.

First, the navigation system 100 provides route information to a set destination.

In a case where the destination is set, the navigation system 100 provides route information including an average speed to the destination, a driving distance at each average speed, and a slope.

For example, the navigation system 100 may provide information on driving distances and slopes in a plurality of average speed sections of 1 to 20 km/h, 21 to 40 km/h, 41 to 60 km/h, 61 to 80 km/h, and 81 to 100 km/h as estimated route information to the destination.

The vehicle controller 200 obtains a first driving distance during a preset time period based on the route information received from the navigation system 100, and a second driving distance that is an actual driving distance during the same time period as the preset time.

For example, the vehicle controller 200 may determine the first driving distance that is a driving distance based on the navigation system 100 for 5 minutes, which is the preset time period, from a difference between a remaining distance to the destination at a time point at which the route information is updated and a remaining distance after 5 minutes has elapsed, and may determine the second driving distance that is an actual driving distance for 5 minutes which is the same as the preset time on the basis of driving information transmitted from the vehicle.

Here, the vehicle controller 200 may compare the first driving distance with the second driving distance to determine the consistency of the route information provided by the navigation system 100, and may monitor whether the setting for an estimated target SoC charging control is achieved normally based on the route information, thereby performing control so that the engine 1 is turned on only when necessary.

The target SoC charging control may obtain a total estimated SoC value to the destination using the route information including an average speed of the vehicle, the driving distance at each average speed, and a slope received from the navigation system 100, and may selectively control ON/OFF of the engine 1 through the vehicle controller 200 according to the obtained total estimated SoC value to control charge and discharge of the battery 2 by the front-wheel motor 10.

In the target SoC charging control, since the estimated route information to the destination is used, in a case where there is an error in the route information, the engine 1 may be turned on unnecessarily for charging. Accordingly, by checking whether the route information is normal through the vehicle controller 200 and selectively stopping the target SoC charging control, it is possible to prevent the problem that the engine 1 is turned on unnecessarily, increasing tailpipe emissions.

In the case of the target SoC charging control, a charging SoC value necessary for additional charging of the battery is obtained by a difference between the total estimated SoC value to the destination determined by a function of the average speed, the driving distance at each average speed, and the slope and a current SoC value to the destination.

TABLE 1

| | | |
|---|---|---|
| Average speed | Driving distance | Slope |

| 10 kph | 0 | m | 0% |
|---|---|---|---|
| 20 kph | 40 | m | +3% |
| 30 kph | 500 | m | −0.5% |
| . | . | | . |
| 80 kph | 530 | m | +0.6% |

Here, the total estimated SoC value may be obtained as “total energy consumption used to destination/predetermined vehicle battery energy capacity”, and the total energy consumption may be obtained from information on a plurality of average speeds provided from the navigation system 100, a driving distance in each of average speed sections, and a slope in each of the average speed sections, as shown in Table 1, for example.

The total energy consumption may be obtained by summing up energy consumptions at average speeds of 10 km/h, 20 km/h, 30 km/h, . . . , and 80 km/h, that is, “(E_driving+E_non_driving)_10 kph+(E_driving+E_non_driving)_20 kph (E_driving+E_non_driving)_30 kph+(E_driving+E_non_driving)_40 kph+ . . . +(E_driving+E_non_driving)_80 kph”. Here, E_driving (energy necessary for driving) at each average speed may be obtained by E_Accel (energy necessary for acceleration)+E_Slop (energy necessary for gradient)+E_RES (energy necessary for general driving), and E_non_driving (energy necessary for non-driving) at each average speed may be obtained by E_HVAC (energy necessary for heating, ventilation, and air conditioning)+E_AUX (energy necessary for electric load).

Using the difference between the total estimated SoC value obtained as described above and the current SoC value, the charging SoC value necessary for additional charging of the battery 2 is obtained. In a case where the charging SoC value is greater than the current SoC value, the charging control is performed by the vehicle controller 200 so that the current SoC value follows the target SoC value.

In a case where the charging SoC value is less than the current SoC value, the charging control or the discharging control is performed by the vehicle controller 200 so that the current SoC value is maintained at the target SoC value, but in a case where the charging SoC value is less than 0, the discharging control is selectively performed.

Referring to FIG. 3, for example, in a case where the remaining distance to the destination is 200 miles and the current SoC value is 30%, the vehicle controller 200 obtains the total estimated SoC value as 250% using the function of the average speed, the driving distance at each average speed, and the slope. Here, since the current SoC value is 30%, the difference between the total estimated SoC value and the current SoC value is 220%, in other words, the charging SoC value is greater than the current SoC value, 30%, the charging control is performed so that the current SoC value follows the target SoC value 80%.

Furthermore, in a case where the remaining distance to the destination is 100 miles and the current SoC value is 80% through charging, the vehicle controller 200 obtains the total estimated SoC value as 140% using the function of the average speed, the driving distance at each average speed, and the slope. Here, since the current SoC value is 80%, the difference between the total estimated SoC value and the current SoC value is 60%, in other words, the charging SoC value is less than the current SoC value, 80%, no charging is necessary, and thus, the charging control or the discharging control is performed so that the current SoC value maintains the target SoC value 80%.

Here, in a case where the remaining distance to the destination is 60 miles and the current SoC value is 80% as the target SoC value is maintained, the vehicle controller 200 obtains the total estimated SoC value as 60% using the function of the average speed, the driving distance at each average speed, and the slope. Here, since the current SoC value is 80%, the difference between the total estimated SoC value and the current SoC value is −20%, that is, the charging SoC value is less than 0, no charging is necessary, which corresponds to a section where the maintenance of the target SoC value is not necessary. Thus, it is determined that the SoC is sufficient to reach the destination, and the discharging control is performed.

However, since the above-mentioned total estimated SoC value uses the route information provided by the navigation system 100, in a case where an error occurs in the route information, the total estimated SoC value for the target SoC charging control may also have an error. To solve the present problem, the vehicle controller 200 determines the consistency of the route information through a difference between a first driving distance and a second driving distance.

In a case where the difference between the first and second driving distances exceeds a reference driving distance, for example, 5 km, the vehicle controller 200 determines that an error has occurred in the provided route information and performs control for stopping the target SoC charging control along with turning on a warning light.

Furthermore, in a case where the difference is less than the reference driving distance, for example, 5 km, the vehicle controller 200 determines that the information on the driving distance in the route information is normal and determines whether an error according to the obtaining of the total estimated SoC value occurs.

To the present end, the vehicle controller 200 obtains a total used SoC value actually used by the vehicle to reach the destination at an end of driving of the vehicle, and compares the total used SoC value with the total estimated SoC value to the destination obtained based on the route information, and performs control for selectively stopping the target SoC charging control.

In a case where the difference between the total used SoC value and the total estimated SoC value is less than a preset error range, for example, 10%, the vehicle controller 200 determines that the obtaining of the total estimated SoC value based on the route information is normal.

Furthermore, in a case where the difference between the total used SoC value and the total estimated SoC value exceeds the preset error range, for example, 10%, the vehicle controller 200 determines that an error has occurred in the obtaining of the total estimated SoC value based on the route information, and performs control for stopping the target SoC charging control along with turning on a warning light.

In the present way, according to the exemplary embodiment of the present disclosure, it is possible to check the consistency of the GPS route information received from the navigation system 100 through the vehicle controller 200, and to check the consistency of an SoC estimation model according to the route information through the difference between the total estimated used SoC value and total used SoC value, and thus, it is possible to selectively stop the target SoC charging control. Thus, it is possible to prevent the engine 1 from being turned on unnecessarily due to the target SoC charging control where an error has occurred, and to prevent the problem of exhaust gas increase in advance.

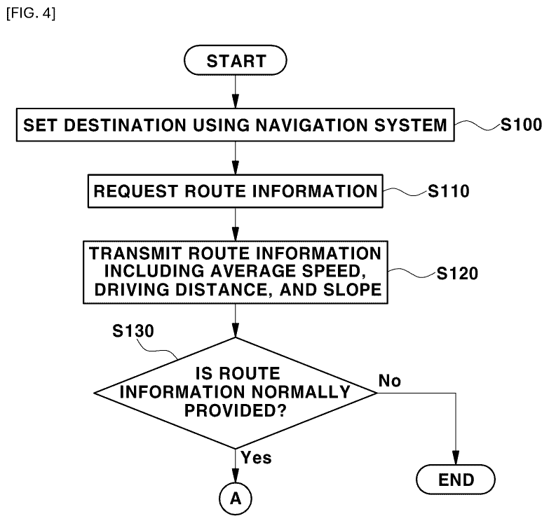

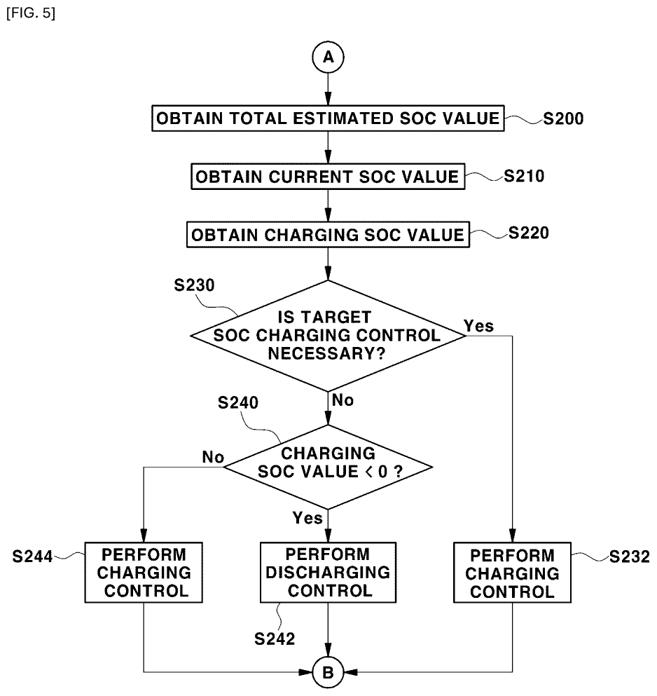

FIG. 4 is a diagram sequentially showing destination setting for a route information monitoring method for a hybrid electric vehicle according to another exemplary embodiment of the present disclosure, and FIG. 5 is a diagram sequentially showing a target SoC charging control for a route information monitoring method for a hybrid electric vehicle according to another exemplary embodiment of the present disclosure.

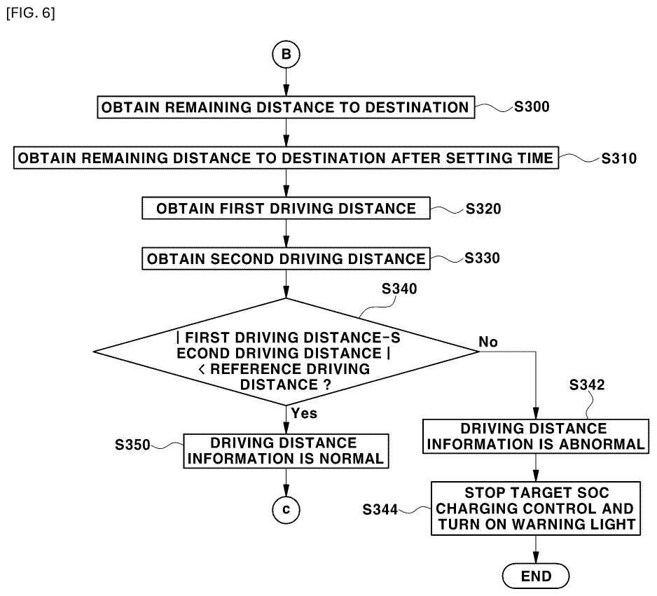

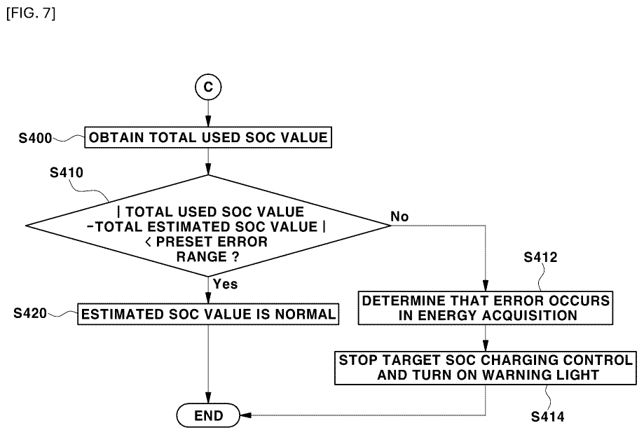

Furthermore, FIG. 6 is a diagram sequentially showing determination of first route information consistency for a route information monitoring method for a hybrid electric vehicle according to another exemplary embodiment of the present disclosure, and FIG. 7 is a diagram sequentially showing determination of second route information consistency for a route information monitoring method for a hybrid electric vehicle according to another exemplary embodiment the present disclosure.

As shown in FIG. 4, in a case where a destination is set by a driver through the navigation system 100 (S100), route information is requested through the navigation system 100 (S110). Here, the vehicle control 200 receives the route information to the destination transmitted from the navigation system 100 (S120).

For example, the navigation system 100 may provide information on driving distances and slopes in a plurality of average speed sections of 1 to 20 km/h, 21 to 40 km/h, 41 to 60 km/h, 61 to 80 km/h, and 81 to 100 km/h as estimated route information to the destination.

Here, as the route information is provided from the navigation system 100 as described above, it is determined whether a signal according to the route information including the average speeds, the driving distances at each average speed, and the slopes to reach the destination is normally provided through CAN communication (S130). based on determining that the signal according to the route information is normal, the target SoC charging control is selectively performed.

In a case where the route information is normally transmitted to the vehicle controller 200, the vehicle controller 200 performs the target SoC charging control based on the route information, as shown in FIG. 5.

That is, for the target SoC charging control, the vehicle controller 200 obtains a total estimated SoC value to the destination determined using the function of the average speeds, the driving distances at each average speed, and the slopes (S200), determines a current SoC value (S210), and obtains a charging SoC value necessary for additional charging of the battery through a difference between the total estimated SoC value and the current SoC value (S220).

In the instant case, the vehicle controller 200 compares the charging SoC value with the current SoC value to check whether the target SoC charging control is necessary. In a case where the charging SoC value is greater than the current SoC value (S230), the vehicle controller 200 performs charging control so that the current SoC value follows the target SoC value (S232).

Furthermore, in a case where the charging SoC value is less than the current SoC value (S230), the vehicle controller 200 determines whether the charging SoC value is less than 0 (S240). In a case where the charging SoC value is less than 0, the vehicle controller 200 performs discharging control (S242), and in a case where the charging SoC value is greater than 0, the vehicle controller 200 performs charging control (S244).

Referring to FIG. 3, in a case where the remaining distance to the destination is 200 miles and the current SoC value is 30%, the vehicle controller 200 obtains the total estimated SoC value as 250% using the function of the average speed, the driving distance at each average speed, and the slope (S200). Here, since the current SoC value is 30% (S210), the difference between the total estimated SoC value and the current SoC value is 220%, in other words, the charging SoC value (S220) is greater than the current SoC value of 30% (S230), the vehicle controller 200 performs charging control so that the current SoC value follows the target SoC value 80% (S232).

Furthermore, in a case where the remaining distance to the destination is 100 miles and the current SoC value is 80% through charging, the vehicle controller 200 obtains the total estimated SoC value as 140% using the function of the average speed, the driving distance at each average speed, and the slope (S200). Here, since the current SoC value is 80% (S210), the difference between the total estimated SoC value and the current SoC value is 60%, in other words, the charging SoC value (S220) is less than the current SoC value of 80% (S230), and is greater than 0 (S240), no charging is necessary, and thus, the vehicle controller 200 performs charging control so that the current SoC value maintains the target SoC value 80% (S244).

Here, in a case where the remaining distance to the destination is 60 miles and the current SoC value is 80% as the target SoC value is maintained, the vehicle controller 200 obtains the total estimated SoC value as 60% using the function of the average speed, the driving distance at each average speed, and the slope (S200). Here, since the current SoC value is 80%, the difference between the total estimated SoC value and the current SoC value is −20%, in other words, the charging SoC value (S220) is less than 0 (S240), no charging is necessary, which corresponds to a section where the maintenance of the target SoC value is not necessary. Thus, it is determined that the SoC is sufficient to reach the destination, and the discharging control is performed (S242).

However, since the above-mentioned total estimated SoC value is determined by the function of the average speed, the driving distance at each average speed, and the slope, in a case where an error occurs in the route information including the same, the total estimated SoC value may also have an error in the obtainment. To solve the present problem, the vehicle controller 200 determines the consistency of the route information through a difference between a first driving distance and a second driving distance, and performs control for selectively stopping the target SoC charging control, as shown in FIG. 6.

That is, the vehicle controller 200 obtains a remaining distance to the destination at a time point at which the route information is updated (S300), and obtains a remaining distance to the destination after a preset time of 5 minutes has elapsed, for example (S310). Accordingly, the vehicle controller 200 obtains a first driving distance that corresponds to a driving distance for 5 minutes based on the navigation system 100 from a difference between the remaining distances (S320).

Furthermore, the vehicle controller 200 obtains an actual driving distance based on the driving information transmitted from the vehicle. That is, the vehicle controller 200 obtains a second driving distance that corresponds to an actual driving distance for 5 minutes which is the same as the preset time (S330).

Accordingly, the vehicle controller 200 compares the first driving distance with the second driving distance to determine the consistency of the route information provided by the navigation system 100, and monitors whether the setting for the estimated target SoC charging control is achieved normally based on the route information.

In other words, in a case where the difference between the first and second driving distances exceeds a reference driving distance, for example, 5 km (S340), the vehicle controller 200 determines that an error has occurred in the provided route information (S342), and performs control for stopping the target SoC charging control along with turning on a warning light (S344).

Furthermore, in a case where the difference between the first driving distance and the second driving distance is less than the reference driving distance, for example, 5 km (S340), the vehicle controller 200 determines that the information on the driving distance in the route information is normal (S350), and determines whether an error according to the obtaining of the total estimated SoC value occurs (see FIG. 7).

Based on determining that the information on the driving distance is normal (S350), the vehicle controller 200 obtains the total used SoC value actually used to reach the destination at an end of driving of the vehicle (S400), as shown in FIG. 7. The vehicle controller 200 compares the total estimated SoC value to the destination obtained based on the route information with the total used SoC value (S410), and performs control for selectively stopping the target SoC charging control.

That is, in a case where the difference between the total used SoC value and the total estimated SoC value is less than a preset error range, for example, 10% (S410), the vehicle controller 200 determines that the obtaining of the total estimated SoC value based on the route information is normal (S420).

Furthermore, in a case where the difference between the total used SoC value and the total estimated SoC value exceeds the preset error range, for example, 10% (S410), the vehicle controller 200 determines that an error has occurred in the obtaining of the total estimated SoC value based on the route information (S412), and performs control for stopping the target SoC charging control along with turning on a warning light, with reference to FIG. 5 (S414).

According to an exemplary embodiment of the present disclosure, it is possible to check the consistency of the GPS route information received from the navigation system 100 through the vehicle controller 200, and to check the consistency of an SoC estimation model according to the route information through the difference between the total estimated SoC value and the total used SoC value, and thus, it is possible to selectively stop the target SoC charging control. Accordingly, it is possible to prevent the engine 1 from being turned on unnecessarily due to the target SoC charging control where an error has occurred, and to prevent the problem of exhaust gas increase in advance.

According to an exemplary embodiment of the present disclosure, by receiving the information on the distance to the destination based on the average speed, the driving distance at each average speed, and the slope from the navigation system, comparing the driving distance based on the navigation system with the actual driving distance, and monitoring whether the route information received from the navigation system is normally operated, it is possible to check the consistency of the route information.

Furthermore, by monitoring whether the SoC is normally controlled by the difference between the estimated SoC value and the actually used SoC at the time of reaching the destination, it is possible to check the consistency of the SoC estimation model according to route information.

Accordingly, based on determining that an error has occurred by checking the consistency of the route information and the consistency of the SoC estimation model according to the route information, it is possible to easily provide a diagnostic result of error occurrence by stopping the target SoC charging control with turning on a warning light.

The present disclosure has been described in detail with reference to exemplary embodiments thereof. However, it will be appreciated by those skilled in the art that changes may be made in these embodiments without departing from the principles and spirit of the present disclosure, the scope of which is defined in the appended claims and their equivalents.

What is claimed is:

1. A route information monitoring apparatus for a hybrid vehicle, the apparatus comprising:
a navigation system that provides route information to a set destination; and
a vehicle controller operatively connected to the navigation system and obtaining a first driving distance during a preset time period based on the route information, obtaining a second driving distance that is an actual driving distance during the same time period as the preset time period, comparing the first driving distance with the second driving distance to determine consistency of the route information for a target SoC charging control, and determining whether to operate an engine of the vehicle for selective battery charging.

2. The apparatus of claim 1, wherein, based on concluding that a difference between the first and second driving distances is less than a reference driving distance, the vehicle controller concludes that the provided route information is normal.

3. The apparatus of claim 1, wherein, based on concluding that a difference between the first and second driving distances exceeds a reference driving distance, the vehicle controller concludes that an error has occurred in the route information, and performs control for stopping the target SoC charging control.

4. The apparatus of claim 1, wherein the vehicle controller obtains a total used SoC value used by the vehicle to reach a destination at an end of driving of the vehicle, compares the total used SoC value with a total estimated SoC value to the destination obtained based on the route information, and performs control for selectively stopping the target SoC charging control.

5. The apparatus of claim 4, wherein, based on concluding that a difference between the total used SoC value and the total estimated SoC value is less than a preset error range, the vehicle controller concludes that the obtaining of the total estimated SoC value based on the route information is normal.

6. The apparatus of claim 4, wherein, based on concluding that a difference between the total used SoC value and the total estimated SoC value exceeds a preset error range, the vehicle controller concludes that an error has occurred in the obtaining of the total estimated SoC value based on the route information, and performs control for stopping the target SoC charging control.

7. The apparatus of claim 1, wherein the target SoC charging control comprises:
obtaining a total estimated SoC value to the destination using the route information including an average speed of the vehicle, the driving distance at each average speed, and a slope received from the navigation system, through the vehicle controller; and
selectively performing charging control or discharging control through the vehicle controller.

8. The apparatus of claim 7, wherein the target SoC charging control comprises:
obtaining a charging SoC value necessary for additional charging of a battery of the vehicle through a difference between the total estimated SoC value and a current SoC value, through the vehicle controller; and
performing the charging control so that the current SoC value follows the target SoC value through the vehicle controller, by the vehicle controller, based on concluding that the charging SoC value is greater than the current SoC value.

9. The apparatus of claim 8, wherein the target SoC charging control comprises performing the charging control or the discharging control by the vehicle controller so that the current SoC value is maintained at the target SoC value, based on concluding that the charging SoC value is less than the current SoC value.

10. The apparatus of claim 9, wherein the target SoC charging control comprises selectively performing the discharging control by the vehicle controller, based on concluding that the charging SoC value is less than 0.

11. A route information monitoring method for a hybrid electric vehicle, the method comprising:
receiving, by a vehicle controller, route information to a destination preset in a navigation system operatively connected to the vehicle controller;
obtaining, by the vehicle controller, a first driving distance during a preset time period based on the route information;
obtaining, by the vehicle controller, a second driving distance that is an actual driving distance during the same time period as the preset time period;
comparing, by the vehicle controller, the first driving distance with the second driving distance to determine consistency of the route information for a preset target SoC charging control; and
determining, by the vehicle controller, whether to operate an engine of the vehicle for selective battery charging.

12. The method of claim 11, wherein the determining of the route information consistency comprises concluding, by the vehicle controller, that the provided route information is normal, based on concluding that a difference between the first and second driving distances is less than a reference driving distance.

13. The method of claim 11, wherein the determining of the route information consistency comprises concluding, by the vehicle controller, that an error has occurred in the route information, based on concluding that a difference between the first and second driving distances exceeds a reference driving distance, and performing, by the vehicle controller, control for stopping the target SoC charging control.

14. The method of claim 11, further comprising:
obtaining, by the vehicle controller, a total used SoC value used by the vehicle to reach a destination at an end of driving of the vehicle;
comparing, by the vehicle controller, the total used SoC value with a total estimated SoC value to the destination obtained based on the route information; and
performing, by the vehicle controller, control for selectively stopping the target SoC charging control.

15. The method of claim 14, further comprising:
based on concluding that a difference between the total used SoC value and the total estimated SoC value is less than a preset error range, concluding, by the vehicle controller, that the obtaining of the total estimated SoC value based on the route information is normal.

16. The method of claim 14, further comprising:
based on concluding that a difference between the total used SoC value and the total estimated SoC value exceeds a preset error range, concluding, by the vehicle controller, that an error has occurred in the obtaining of the total estimated SoC value based on the route information, and performing, by the vehicle controller, control for stopping the target SoC charging control.

17. The method of claim 11, wherein the target SoC charging control comprises:
obtaining, by the vehicle controller, a total estimated SoC value to the destination using the route information including an average speed of the vehicle, the driving distance at each average speed, and a slope received from the navigation system; and
selectively performing, by the vehicle controller, charging control or discharging control.

18. The method of claim 17, wherein the target SoC charging control comprises:
obtaining, by the vehicle controller, a charging SoC value necessary for additional charging of a battery of the vehicle through a difference between the total estimated SoC value and a current SoC value, and
performing, by the vehicle controller, the charging control so that the current SoC value follows the target SoC value based on concluding that the charging SoC value is greater than the current SoC value.

19. The method of claim 18, wherein the target SoC charging control comprises performing, by the vehicle controller, the charging control or the discharging control by the vehicle controller so that the current SoC value is maintained at the target SoC value, based on concluding that the charging SoC value is less than the current SoC value.

20. The method of claim 19, wherein the target SoC charging control comprises selectively performing, by the vehicle controller, the discharging control, based on concluding that the charging SoC value is less than 0.
